(19) United States
(12) Patent Application Publication
(10) Pub. No.: US 2002/0071291 A1
(43) Pub. Date: Jun. 13, 2002

(54) DC-DC converter

(75) Inventor: Keith Johnson, Ennis (GB)

Correspondence Address: David M. Carter, Carter & Schnedler, P.A., 56 Central Avenue, Suite 101, P.O. Box 2985, Asheville, NC, 28802, US

(73) Assignee: Power-One AG, Uster (CH)

(21) Appl. No.: 10/012,893

(22) Filed: Nov. 5, 2001

(30) Foreign Application Priority Data
Nov. 9, 2000 (DE) 200 19 056.3

(51) Int. Cl. H02M 3/335

(52) U.S. Cl. 363/16

(57) ABSTRACT

There is provided a DC-DC converter for a plurality of output voltages. A transformer device is provided to which primary voltage produced from an input voltage can be applied at the primary side. A plurality of branches are provided at the secondary side having respective rectifier means and which are adapted to provide output voltage signals. The transformer device is in the form of a plurality of magnetically mutually separated transformers corresponding to the plurality of output voltages, whereby the primary windings of the transformers are connected and parallel for application of the primary voltage, and associated with each secondary winding of the plurality of transformers is one of a plurality of network branches.

### BACKGROUND OF THE INVENTION

The present invention concerns a DC-DC converter, in particular for use in the high-frequency range.

DC-DC converters are known from the state of the art, which provide potential-linked doubled output voltages; the background to structures of that kind is in particular the fact that, with modern integrated circuits, the supply voltages continuously drop and taking account of both earlier and also more recent ICs within the same circuit then calls for suitably different supply voltages in order to be able to operate those circuits in side-by-side relationship.

Traditionally, that is effected by current supply being implemented by using a transformer with a primary side, the primary winding thereof being fed by a switching transistor which is actuated in a suitably pulsed manner (for example an MOSFET). On the secondary side there is then either a take-off (tapping) or separate windings are provided so that a further secondary voltage can be produced and supplied separately to respective consumers.

By virtue of in part high output currents transformers of that kind usually have only a small number of turns.

While a technology of that kind, which is known as being state of the art, permits comparatively flexible load distribution on the secondary side, the voltage combinations which can be achieved are limited however, due to the possible combinations of numbers of turns (with the smallest possible number of turns); a typical situation of use is an output voltage of 5 volts which is produced by means of three secondary windings, wherein the secondary winding has a tapping in the case of two turns for an additional output voltage of 3.3 volts. Having regard to the respective voltage drops on the secondary side, at the downstream-connected rectifier diodes, that thus affords the desired output voltages.

FIG. 1 shows such a technology which is known from the state of the art, by means of a circuit diagram showing the principle involved: the primary winding Npri of a transformer TR1 is actuated at the primary side by an MOSFET Q which is operated in a clock cycle d. The primary voltage Vpri is correspondingly produced by way of the primary winding.

On the secondary side the transformer TR1 has two secondary windings Nsec1 and Nsec2 with a number of windings selected in accordance with a respectively desired output voltage Vout1 and Vout2 respectively. Besides a rectifier diode D1 (and D2 for the other branch) each network branch at the secondary side has a free-running diode D3 (or D4 respectively), an inductor L1 (or L2 respectively) and a capacitor C1 (or C2 respectively), by way of which the respective output voltage is then tapped off.

If the voltage drop across the respective rectifier diode D1 through D4 is assumed to be identical as Vf, then that gives the following, for the respective output voltages:

Vout1={(Nsec1/Npri)×Vpri×d}−Vf (1)

Vout2={(Nsec2/Npri)×Vpri×d}−Vf (2)

That then gives the following:

(Vout2+Vf)=(Nsec2/Nsec1)×(Vout1+Vf) (3)

It follows from this relationship that (in the case of the same voltage drop Vf in both branches, which is to be assumed to be typical), the respective output voltages Vout1 and Vout2 are proportional in their relationship to the number of turns Nsec1 and Nsec2.

As moreover it is not possible to provide partial turns on the secondary side, that involves (in view of the necessity to keep the absolute number of turns as small as possible) the above-described problem of the low level of flexibility of the possible output voltages which can be produced at the secondary side, as they depend directly on an integral secondary-side ratio in respect of the number of turns.

### OBJECTS OF THE INVENTION

Therefore the object of the present invention is to improve a known DC-DC converter of the general kind set forth, in such a way that a plurality of output voltages of the converter circuit can be produced on the secondary side in a more flexible fashion and preferably independently of a ratio of integral secondary-side numbers of turns, while moreover in accordance with the object of the invention it is possible to avoid high leakage inductances or high ohmic losses in the transformer arrangement (as would otherwise be the case with high numbers of turns selected in order to achieve any voltage ratios).

That object is attained by the DC-DC converter having the features of the main claim; advantageous developments of the invention are set forth in the appendant claims.

### SUMMARY OF THE INVENTION

In accordance with the invention the problem of the low level of flexibility which is linked to the integral turns ratios or tappings on the secondary side, in regard to determining voltage on the output side, is resolved by the provision of a plurality of transformers corresponding to the plurality of the desired output voltages, wherein the respective primary windings of those transformers are actuated in parallel by a common electronic switching arrangement (for example MOSFETs as switches).

In contrast once again associated with each secondary winding is its own secondary network which then provides a respective output voltage in rectified form.

In a particularly simple and elegant manner it is thus possible that respective suitable secondary winding ratios can be adopted for the plurality of transformers and then fine tuning is possible by slightly differing numbers of primary windings on the primary side. Added to that is the fact of smaller (lighter) individual transformers.

In accordance with a development in that respect it has proven worthwhile to provide on the primary side a clock-controlled or cyclically operated MOSFET for supplying the parallel-connected primary winding with electrical energy, just as it is desirable in accordance with a preferred embodiment to adopt rectifier means for producing the dc output voltages, on the secondary side (in otherwise known manner).

Thus, in the described fashion, it is possible to produce a DC-DC converter in an extremely simple and flexible fashion, which permits the required flexibility while being of the simplest structural implementation, in particular also in regard to future new voltage ranges (for example 1.8 volt, 2.5 volts and 3.3 volts).

### BRIEF DESCRIPTION OF THE DRAWINGS

Further advantages, features and details of the invention will be apparent from the description hereinafter of an embodiment with reference to the drawings in which:

FIG. 1 shows a circuit diagram of a DC-DC converter apparatus known from the state of the art, and

FIG. 2 shows a circuit diagram of a DC-DC converter apparatus which is modified in accordance with the present invention and which permits flexibilization in terms of the nature of the respective output voltages.

### DESCRIPTION OF THE PREFERRED EMBODIMENT

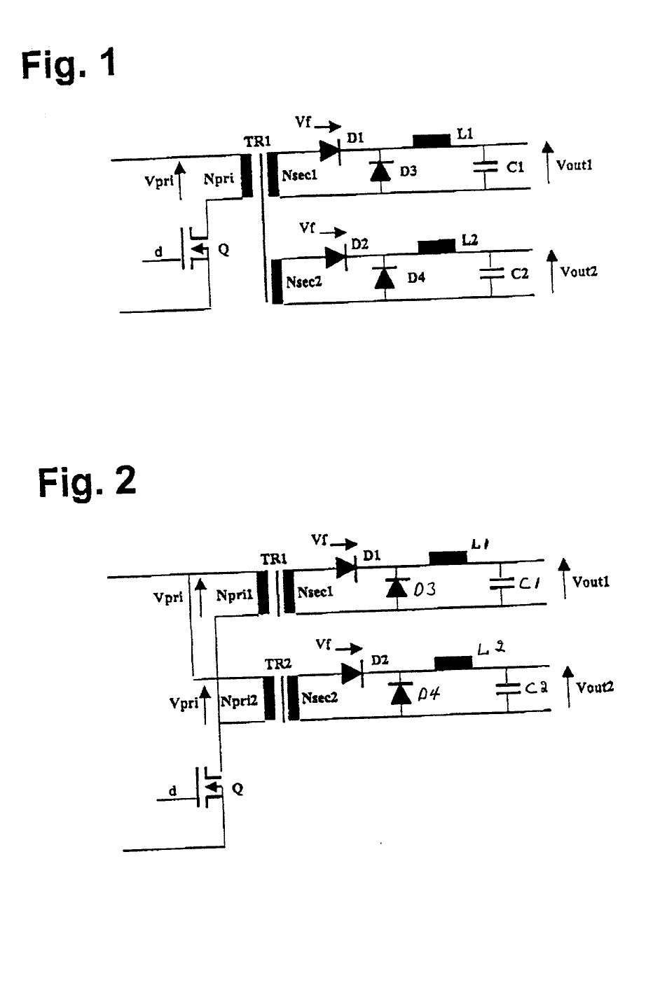

In specific terms the circuitry implementation on the secondary side in the embodiment of FIG. 2 corresponds to the respective network branches, as have been described hereinbefore with reference to FIG. 1.

In contrast it is found that there are now also separate windings on the primary side as, in accordance with the embodiment in FIG. 2, the common transformer TR1 (FIG. 1) which is provided from the state of the art has now been replaced by two magnetically mutually independent (and correspondingly smaller) transformers TR1 and TR2 which each have a separate primary winding Npri1 and Npri2. As can be seen from the circuit diagram in FIG. 2 those two primary windings are in parallel with each other and are supplied jointly with energy by the MOSFET Q so that there is a common primary voltage Vpri.

As equations (4) and (5) hereinafter clearly show, similarly to the equations (1) and (2) as shown in FIG. 1, the respective output voltages Vout1 and Vout2 are completely independent of each other in respect of their relative number of turns and the ratio thereof:

Vout1={(Nsec1/Npri1)×Vpri×d}−Vf (4)

Vout2={(Nsec2/Npri2)×Vpri×d}−Vf (5)

That makes it impressively clear that precise adjustment of a respective secondary voltage can be effected by suitable selection of the number of turns for the respective secondary winding (and, especially for fine adjustment, of the primary winding) and the common primary-side MOSFET (with a single electronic actuating system) still supplies the parallel circuit arrangement of the primary windings jointly with energy.

While the illustrated circuit diagrams show a through-flow converter as the circuitry topology, the invention equally embraces using any other (suitable) topologies, for example a blocking converter, or a half-bridge or a full bridge.

1. A DC-DC converter for a plurality of output voltages (Vout1, Vout2), comprising:
a transformer device to which a primary voltage (Vpri) produced from an input voltage to be converted can be applied at the primary side, and
a plurality of network branches (D1, D3, L1, C1; D2, D4, L2, C2) which are provided at the secondary side and which have respective rectifier means (D1, D2) and which are adapted to output a respective output voltage signal,
characterized in that
the transformer device is in the form of a plurality of magnetically mutually separated transformers (TR1, TR2) corresponding to the plurality of output voltages (Vout1, Vout2),
wherein the primary windings of the transformers are connected in parallel for application of the primary voltage (Vpri), and
associated with each secondary winding of the plurality of transformers is one of the plurality of network branches.

2. A converter as set forth in claim 1 characterized in that the rectifier means have a rectifier diode (D1, D2) or another semiconductor switching element, in particular a synchronous MOSFET.

3. A converter as set forth in claim 1 characterized in that provided on the primary side are means for supplying the plurality of primary windings with electrical energy, which are in the form of a clock-controlled MOSFET (Q) provided jointly for the plurality of primary windings.

4. A converter as set forth in claim 1 characterized in that the number of turns of the secondary windings are determined and adapted differently in accordance with a respective output voltage.

5. A converter as set forth in claim 1 characterized in that the number of turns of the primary windings are determined and adapted differently in accordance with a respective output voltage.

6. A converter as set forth in claim 1 characterized in that the network branches have a circuitry topology of through-flow, blocking converter, half-bridge or full-bridge type.
